(19) United States
(12) Patent Application Publication
(10) Pub. No.: US 2003/0094054 A1
(43) Pub. Date: May 22, 2003

(54) Device for determining the steering angle of a steering wheel

(75) Inventor: Joachim Font, Hauenstein (DE)

Correspondence Address: FOLEY AND LARDNER, SUITE 500, 3000 K STREET NW, WASHINGTON, DC, 20007, US

(73) Assignee: TAKATA-PETRI AG

(21) Appl. No.: 10/299,723

(22) Filed: Nov. 20, 2002

(30) Foreign Application Priority Data
Nov. 20, 2001 (DE) 101 58 287.0

(51) Int. Cl. G01L 3/02

(52) U.S. Cl. 73/862.328

(57) ABSTRACT

A device for determining the steering angle of a steering wheel. The device includes a code carrier and a device for sensing a code which is provided on the code carrier, which code carrier and device are rotated with respect to one another when the steering angle changes, the device for sensing the code generating an output signal from which the steering angle can be determined. The code carrier is formed by means of one of two gear mechanism elements, which are arranged one behind the other on a common axle and have an operative connection to a drive element, which is driven by the steering wheel, and which are rotated with respect to one another when the steering angle changes.

### BACKGROUND OF THE INVENTION

The invention relates to a device for determining the steering angle of a steering wheel that includes a code carrier and a device for sensing a code, which is provided on the code carrier, where the code carrier and device for sensing a code are moved with respect to one another when the steering angle changes, the device for sensing the code generating an output signal from which the steering angle can be determined. Such a device is disclosed by German patent application 101 58 287.0, filed Nov. 20, 2001, which is hereby incorporated by reference herein.

Such systems for determining the steering angle of a steering wheel, in particular in motor vehicles, are generally known.

Particular problems may occur in the implementation of such systems if the steering angle is to be determined not only between the values of 0° and 360° but also if, in addition, the number of complete rotations of the steering wheel is also to be detected. Such systems for determining the steering angle are required, in particular, if the rear axle of a vehicle is to be electronically controlled directly via the steering angle sensor, or if the carriageway is to be illuminated in a variable way with the lighting device of a motor vehicle depending on the direction of travel.

Here, there is the problem that the rotation counter is to be activated even if the electrical system of the respective vehicle is switched off. This rules out a purely electronic solution if an additional storage battery mode is not to be used.

DE 1 98 07 522 A1 (incorporated by reference herein) discloses that a belt which is guided around the steering axle and whose position is sensed by means of a sensor is used to determine the steering angle. The system is configured in such a way that the belt runs round at most once when there are a plurality of rotations of the steering wheel.

EP 0 853 355 A2 (incorporated by reference herein) discloses a single-stage gear mechanism solution with an internal gearwheel which is mounted on the steering axle and an assigned external gearwheel, which gearwheels are provided with a different number of teeth.

An object of the invention is to further improve a device for determining the steering angle of a steering wheel of the type described above.

### SUMMARY OF THE INVENTION

One object of the present invention is to provide a device for sensing the steering angle of a steering wheel with which the number of rotations of the steering wheel can easily be determined.

According to an embodiment of the present invention, a device is provided having a code carrier and a device for sensing a code, which is provided on the code carrier. When the steering angle changes, the code carrier and the device for sensing the code are moved with respect to one another, the device for sensing the code generating an output signal from which the steering angle can be determined. The code carrier is formed by one of two gear mechanism elements which are arranged axially one behind the other on a common axle, have an operative connection to a drive element that is driven by the steering wheel, and are rotated with respect to one another when the steering angle changes.

The present invention is based in part on using gear mechanism technology, in which two gear mechanism elements, which are arranged coaxially with respect to one another, have an operative connection to a common drive element, for achieving a high transmission ratio in a device for sensing the steering angle of a steering wheel. In this way, not only the respective steering angle between 0° and 360° can be determined by reference to the rotational movement of the respective gear mechanism element, but also, in particular, the number of rotations of the steering wheel can be determined on the basis of a defined zero point position. In particular, the steering angle is not simply understood here as being an angle between 0° and 360°, but also the steering angle is considered to be an absolute steering angle which is progressively increased on the basis of a reference position when the steering wheel rotates, for example, when there are ten possible rotations of the steering wheel between 0° and 360°.

The device according to the present invention serves not primarily for precisely determining the steering angle between 0° and 360°, but rather for determining the number of rotations of the steering wheel on the basis of the zero point position. One function of the present invention is, therefore, in particular to correctly sense multiples of 360° (i.e., complete rotations) when determining the absolute steering angle, measured progressively starting from the zero point position of the steering wheel. If appropriate, an additional steering angle sensor can be used for precisely determining the respective steering angle within one rotation (that is to say between 0° and 360° and 720°, etc.).

A code, and an assigned device for sensing the code, are understood here to be any desired assemblies which can move with respect to one another and which generate, on the basis of a relative movement, an output signal that can be used to sense the degree of rotational movement of the gear mechanism element that is provided with the code. In order to sense the code, in particular, electrical, magnetic, or optical measuring principles can be applied. Thus, the change in an electrical resistance, which occurs when the respective gear mechanism element rotates, can be determined, specifically by using a potentiometer that produces the code in the form of an electrical resistance and the assigned sensing device in the form of a tap. In addition to this sensing arrangement, which is particularly easy to implement, for example, a magnetic measuring principle, which is based on the Hall effect, or an optical measuring principle, which is based on the sensing of defined marks, can be used.

One advantage of the present invention is that, as a one-step solution, it can be implemented in an expansive and technically simple way. Furthermore, the device according to the present invention operates without much noise.

Gearwheels that engage with at least one corresponding toothing of the drive element are particularly suitable as gear mechanism elements which are arranged axially one behind the other.

The two gear mechanism elements are arranged and configured in such a way that, when there is a change in the steering angle, they are rotated with respect to one another through an angle which is considerably smaller than the steering angle, preferably in such a way that, when there is the maximum possible change in the steering angle (corresponding to the maximum possible number of rotations of the steering wheel), the two gear mechanism elements are rotated with respect to one another through an angle of less than 360°.

The two gear mechanism elements are preferably mounted coaxially on the steering axle.

It is also advantageous that one of the two gear mechanism elements is mounted fixed in terms of rotation, and the other is mounted in a rotatable fashion, on the common axle, with the rotatably mounted gear mechanism element being used as the code carrier, that is to say, being provided with the code to be sensed.

The necessary transmission ratio can be obtained in particular as a result of the two gear mechanism elements having a different number of teeth, the smallest possible difference in the number of teeth (for example, one gearwheel with 50 teeth and one gearwheel with 49 teeth) is advantageous.

The drive element which is driven when the steering wheel rotates (in accordance with a change in the steering angle), and which in the process acts on the two gear mechanism elements, may be in particular a gearwheel that is mounted rotatably (about its central axis) and whose diameter is smaller than the diameter of the two gear mechanism elements and which forms a planetary wheel in relation to the gear mechanism elements.

When the two gear mechanism elements are arranged axially one behind the other on the steering axle, the axis of rotation of the drive element runs parallel to said steering axle and the drive element has two toothing regions, which are arranged axially one behind the other, each of which is in engagement with one of the two gear mechanism elements.

According to one embodiment of the present invention, the two toothing regions of the drive element have the same shape and number of teeth. However, it is also possible to provide toothing regions with different shapes and with a different number of teeth.

In addition, a plurality of drive elements may be provided which are arranged spaced apart from one another along the circumference of the two gear mechanism elements. In this way, improved centering of the gear mechanism and improved tolerance compensation can be achieved while simultaneously avoiding imbalances.

According to another embodiment of the present invention, the two gear mechanism elements each have an external toothing into which the drive elements engages. Alternatively, it is possible to provide one internal toothing on each of the two gear mechanism elements, into which internal toothing the drive element engages.

In addition, the toothing of at least one of the two gear mechanism elements can have a variation in the formation of the teeth along the circumference of the gear mechanism element. As a result, a non-linearity in the transmission ratio can be brought about. This provides the possibility of providing blind regions on the corresponding gear mechanism element, and when said blind regions interact with the drive element, no relative movement of the two gear mechanism elements takes place, that is to say, it is also the case that no correspondingly changed output signals (sensor signals) are generated by the sensing device. The wear of the sensing device, in particular when travelling straight ahead, can thus be minimized. In a borderline case, in this embodiment it is possible to bring about a switching over of the two gear mechanism elements with respect to one another rather than a continuous rotation.

In a preferred embodiment of the invention, the drive element is mounted in a moveable fashion such that tolerances as regards the position of the gear elements arranged on a common axle and engaged with the drive element can be compensated. Since these gear elements are preferably arranged on the steering axle of a steering wheel arrangement, the tolerances as regards the arrangement and adaptation of the steering column and the steering wheel arrangement directly affect the position of the said gear elements. Typically, there are radial and axial tolerances at the steering column in the order of two millimeters as well as a tipping (out of true) of up to two degrees. In order to compensate such tolerances in the position of the gear elements, the assigned drive element is movable in the radial and/or axial direction. Preferably, the drive element is biased elastically in the direction of a preferred position in which it engages the gear element and, in order to compensate for tolerances, can be moved such that the engagement into the gear elements can be maintained. That is, the drive element mounted flexibly by means of an elastic element can adapt axially or radially to deviations caused by tolerances in the position of the assigned gear elements.

In addition to providing a simple compensation of tolerances, one objective of the present invention—in contrast to common planetary gear mechanisms—is that load transmission into the gear mechanism serving the steering angle measurement system takes place through the planetary wheel as drive element. This is because, on rotation of the steering wheel, it rotates along a circular path whose center is formed by the central axis of both gear elements which interact with the drive element while rotating around its own axis. Thereby and particularly by the coincidence of the steering axle and the center axis of the drive elements, a simple and compact construction of the gear mechanism is possible on the basis of only few gear elements.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows an exploded view of a device for determining the steering wheel steering angle having two gearwheels which are arranged coaxially one behind the other and having external toothing and a drive pinion which is in engagement with the two gearwheels and which is also carried along when the steering angle changes;

FIG. 2a shows a view of the device from FIG. 1 in the mounted state from below;

FIG. 2b shows a perspective view of the device from FIG. 1 in the mounted state;

FIG. 2c shows a side view of the device from FIG. 1 in the mounted state;

FIG. 3a shows an exploded view of a first refinement of the exemplary embodiment from FIGS. 1 to 2c;

FIG. 3b shows a device from FIG. 3a in a partially assembled state;

FIG. 3c shows a side view of the device from FIGS. 3a and 3b;

FIG. 4a shows an exploded view of a second refinement of the device from FIGS. 1 to 2c, the two coaxially mounted gearwheels each having an internal toothing;

FIG. 4b shows the device from FIG. 4a in a partially assembled state; and

FIG. 4c shows a side view of the device from FIGS. 4a and 4b.

### DETAILED DESCRIPTION OF THE PREFERRED EMBODIMENTS

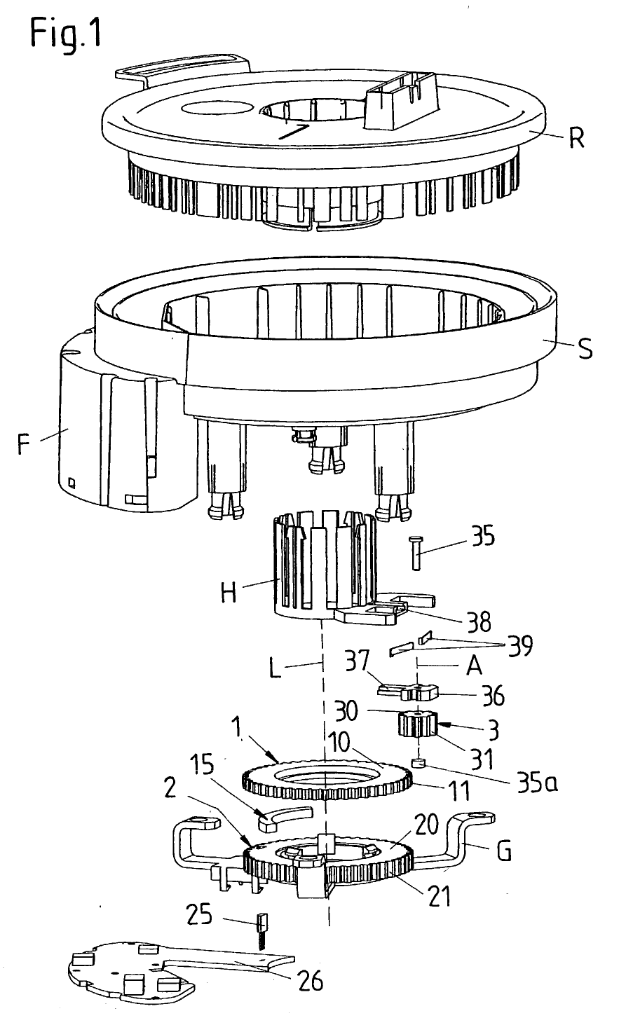

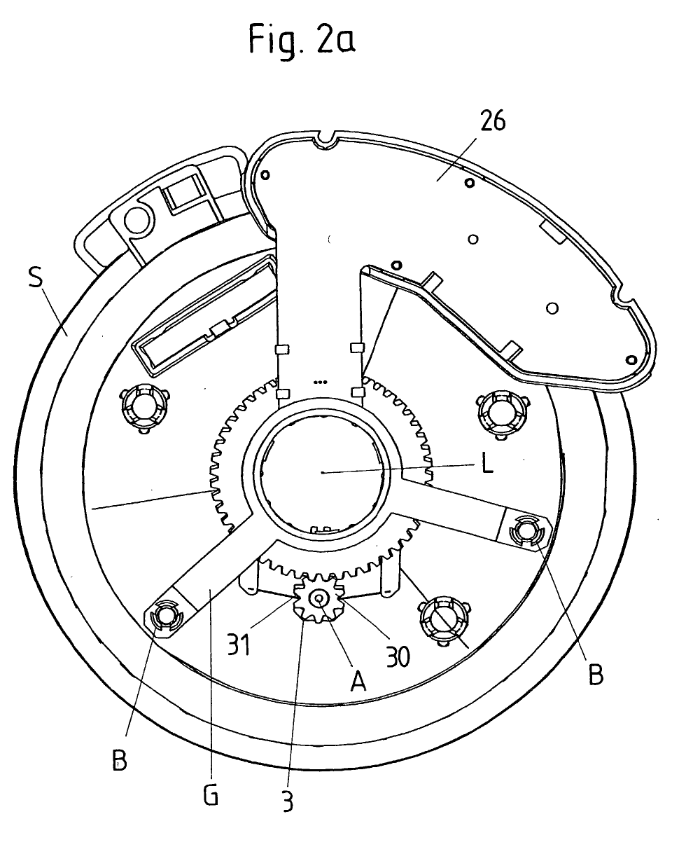

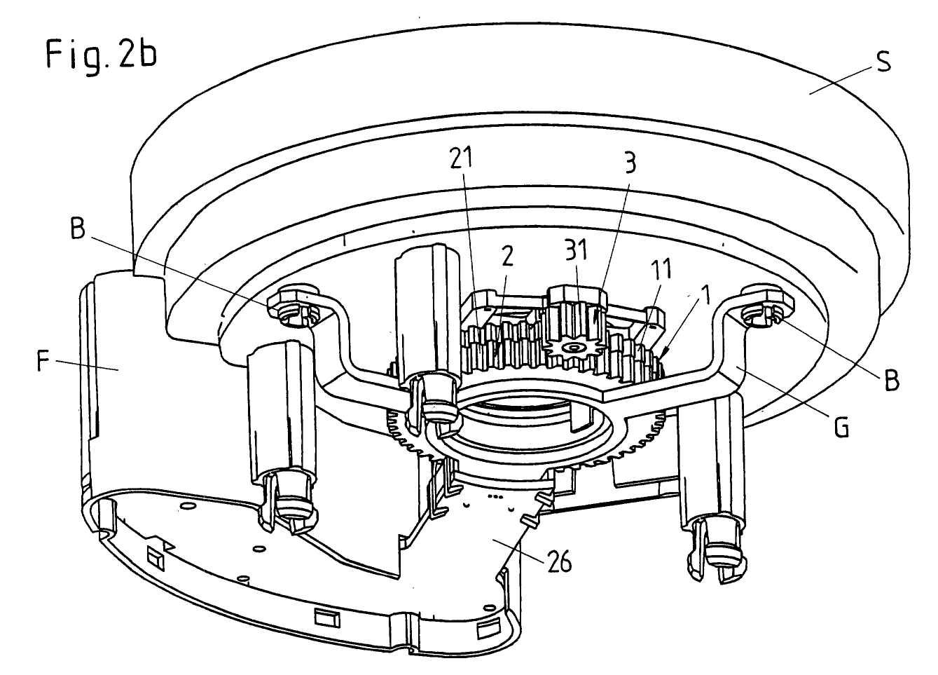

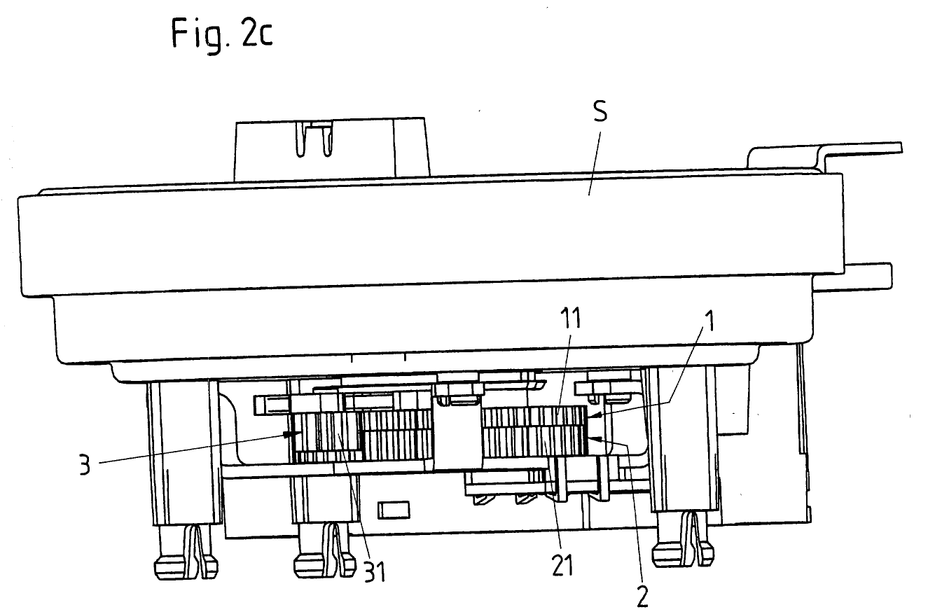

FIGS. 1 to 2c show various views of a steering angle sensor device for a motor vehicle having a rotor R and a stator S. The rotor R is connected to the steering wheel in such a way that it is rotated, for example via a steering spindle, when the steering wheel rotates about the steering axle L. The stator S is, in contrast, attached by means of suitable attachment elements to a fixed assembly of the motor vehicle which cannot move together with the steering wheel. The rotor-stator arrangement which is illustrated in FIG. 1 is configured in such a way that it is suitable for transmitting electrical signals between rotor R and stator S by means of electrical lines which extend from the rotor to the stator and which are wound on or unwound during a rotational movement. Such a rotor-stator arrangement is known, for example, from DE 200 07 862 U1. Reference is made herewith to the entire content of said document with respect to further details of the rotor-stator arrangement and in particular its coupling to a steering device.

The particular feature of the arrangement illustrated in FIGS. 1 to 2c is the device for sensing the steering angle, i.e. that angle through which the rotor is rotated when the steering wheel rotates. The aim here is not primarily to determine the steering angle within one rotation of the steering wheel, i.e. in an angular range between 0° and 360°, but rather in particular to determine the number of rotations of the steering wheel on the basis of a defined reference position of the steering wheel.

The device which is provided for this purpose comprises two gearwheels 1, 2 which are arranged coaxially one behind the other on the steering axle L and have an annular base body 10, 20 and in each case an external toothing 11, 21. The one gearwheel 1 is mounted in a freely rotatable fashion on the steering axle L, and the other gearwheel 2 is secured fixed in terms of rotation to the stator S by means of a frame G and attachment means B.

The two gearwheels 1, 2 which can rotate with respect to one another are assigned a planetary gearwheel 3 which is rotatably mounted at the external edge of a holding sleeve A by means of a bearing bolt 35 and a bearing element 36 which is held so as to be radially movable in respect of the steering axle L in a positively engaging fashion in a T groove 38 on the external edge of the holding sleeve H by means of an attachment section 37, said holding sleeve A being permanently connected to the rotor R, that is to say rotates together with it. This means that when the rotor R rotates (triggered by a rotation of the assigned steering wheel) the sleeve H is pivoted together with the rotor R around the steering axle L, and that in the process the planetary gearwheel 3 is carried along by the sleeve H.

The toothing 31 which is provided on the base body 30 of the planetary gearwheel 3 is configured in such a way that it intermeshes both with the external toothing 11 of the first gearwheel 1 which is mounted in a freely rotatable fashion and with the external toothing 21 of the second gearwheel 2 which is mounted fixed in terms of rotation. This means that when the steering wheel, and thus the rotor R rotate, together with the holding sleeve H, the planetary gearwheel 3 rolls with its toothing 31 on the external toothings 11, 21 of the two gearwheels 1, 2. As the planetary gearwheel 3 is mounted so as to be capable of rotating about an axis A which runs parallel to the steering axle L, by means of the bearing bolt 35 and the bearing element 36 which is held so as to be movable longitudially in a positively engaging fashion in a T groove 38 on the external edge of the holding sleeve H by means of the attachment section 37 of said bearing element 36, the planetary gearwheel 3 rotates about its axis A in the process.

Due to the arrangement of the bearing element 36 so as to be capable of longitudinal movement and the planetary gearwheel mounted thereon, tolerances in the position of the two gearwheels 1, 2 can be compensated in a radial direction. Such tolerances are due to radial tolerances in the order of approximately two millimeters of the steering column defining the steering axle L of a steering mechanism. In the present case, these can be compensated for simply by a radial movement of the attachment section 37 of the bearing element 36 in the assigned T groove 38. For this purpose, the bearing element 36 is biased in respect of the T groove 28 of the holding sleeve H in a direction of the gearwheels 1 and 2, thereby abutting upon them permanently, by means of elastic means 39 in the form of spring steel elements. In order to compensate for tolerances, the bearing element 36 can be positioned radially relative to the steering axle L by means of this bias such that engagement into the gearwheels 1, 2 is guaranteed.

By moving the bearing element 36 together with the planetary gearwheel 3 on the bearing bolt 35 formed as a screw which is limited axially at one end by the screw head and at the other end by a nut 35a, axial tolerances as regards the arrangement of the gearwheels 1, 2 can also be compensated for. Finally, a combined movement of the bearing element 36 in the axial direction (along the steering axle L) as well as radially (perpendicular to the steering axle L) provides for a compensation of tippings of the steering columns (out of true) which typically amount to up to two degrees.

In addition to the above explained simple compensation of tolerances, the gear mechanism illustrated in FIGS. 1 to 2c is characterised by a simple construction requiring only a small number of gear elements (three gear elements 1, 2, 3 overall). This is achieved mainly by arranging the gearwheels 1, 2 on the steering axle L and transmitting load into the gear mechanism through the planetary gearwheel 3.

The toothing 31 of the drive gearwheel 3 is formed, as it were, by means of two toothing regions which are arranged axially one behind the other and are identical (and therefore not shown separately in the figures), one of which toothing regions being in engagement with the first gearwheel 1 and the second with the second gearwheel 2. If appropriate, the two toothing regions can also have different toothings.

The external toothings 11, 21 of the two gearwheels 1, 2 which are mounted on the steering axle L preferably have the same or a similar module of the toothing 31 of the planetary gearwheel 3.

However, the two gearwheels 1, 2 have a slightly different number of teeth, for example 49 teeth on the one hand and 50 teeth on the other, which results in a slight rotation of the two gearwheels 1, 2 with respect to one another when the planetary gearwheel 3 circulates, i.e., the first gearwheel 1 which is mounted in a freely rotatable fashion is rotated slightly with respect to the second gearwheel 2 which is arranged fixed in terms of rotation.

The offset between the two gearwheels 1, 2 after a rotation of the gearwheel can be sensed by means of a sensor device 15, 25 which is provided for this purpose; and the same applies to the increasing offset at each further rotation of the steering wheel, and thus of the rotor R, during which the planetary gearwheel 3 is carried along and rolls on the external toothings 11, 21 of the two gearwheels 1, 2 which are mounted on the steering axle L. When there is a sufficiently small difference in the number of teeth of the two external toothings 11, 21 and a correspondingly large transmission ratio it is possible to ensure that at the maximum possible number of rotations of the steering wheel (for example ten rotations) the offset of the two gearwheels 1, 2 with respect to one another (that is to say the relative rotation of the first gearwheel 1 which is mounted in a freely rotatable fashion, with respect to the gearwheel 2 which is arranged in a rotationally fixed fashion) is a maximum of 360° or less. In this case, the number of rotations of the rotor R, and thus of the steering wheel, can be read off directly from each position of the two gearwheels 1, 2 with respect to one another.

The resolution within one rotation (corresponding to a steering angle between 0° and 360°) is thus smaller so that, under certain circumstances, an additional sensor has to be used to determine the steering angle within one rotation precisely. The device provided for determining the number of rotations can then be used additionally for monitoring this further sensor by means of plausibility checks.

The sensor device 15, 25 is formed here by a magnet 15 which extends in the manner of a ring along part of the circumference of the first gearwheel 1. This magnet 15 generates a magnetic code which can be sensed by means of an assigned magnetic-field-sensitive sensor element 25 which is mounted a plate 26. The plate 26 is attached to a projection F of the stator S so that the magnetic-field-sensitive sensor element 25 is mounted in position in a fixed fashion. The magnetic field at the location of the sensor element 25 thus depends on the relative position of the first gearwheel 1, which is fitted with the magnet 15, with respect to the second gearwheel 2. As a result, the relative position of the two gearwheels 1, 2, and thus, as explained above, the absolute rotational angle (including the number of rotations of the steering wheel and thus of the rotor R) can be determined.

Instead of two gearwheels mounted on the steering axle L it is possible, when required, also to use more gearwheels for this.

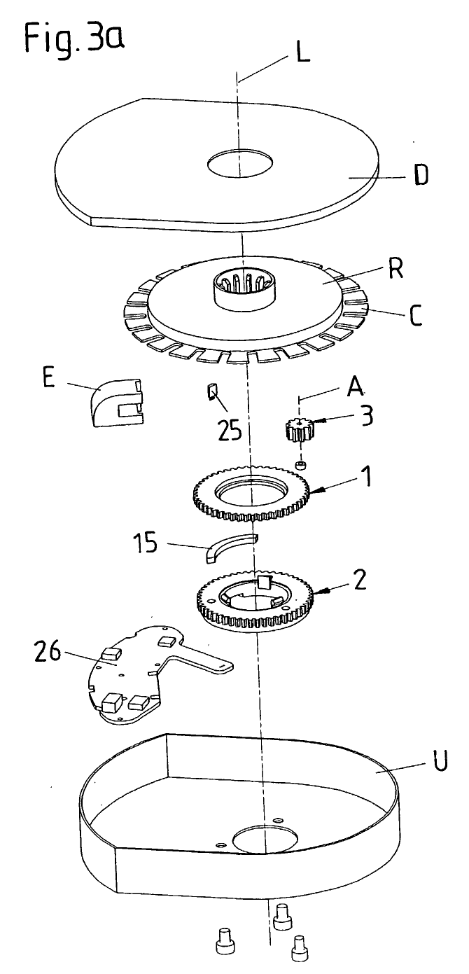

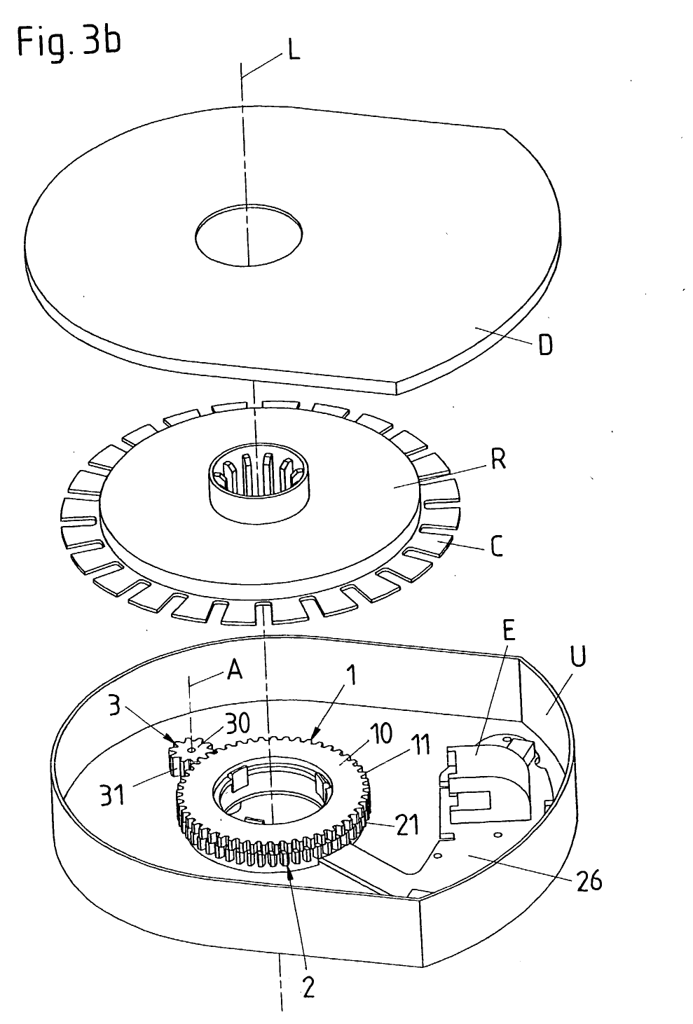

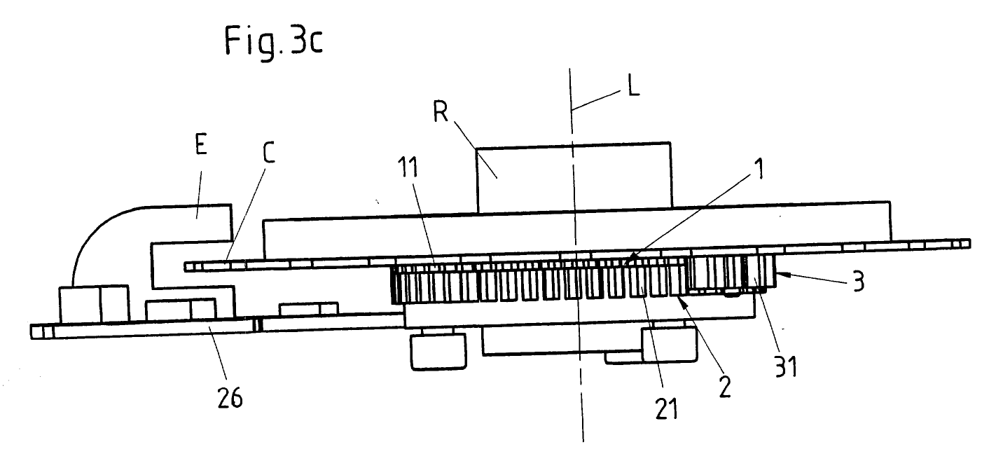

The exemplary embodiment of the invention which is illustrated in FIGS. 3a to 3c differs essentially from that which is described with respect to FIGS. 1 to 2c in that the rotor-stator arrangement is not designed to transmit electrical signals between the rotor and the stator. In this case, the stator is formed by a simple housing composed of a lower part U and a cover D in which the rotor R is rotatably mounted.

A further difference is that the rotor R is provided at its circumference with a coding C which can be sensed optically by means of a sensing device E. Said coding C serves to determine more precisely the steering angle within one rotation of the steering wheel. The sensing device E which is used for this can comprise in the usual way a transmitter and an assigned receiver with which the coding C is sensed, for example using a through-lighting method.

Otherwise, the exemplary embodiment presented by means of FIGS. 3a to 3c corresponds to what was explained with reference to FIGS. 1 to 2c so that in this respect reference is made to the statements relating to FIGS. 1 to 2c.

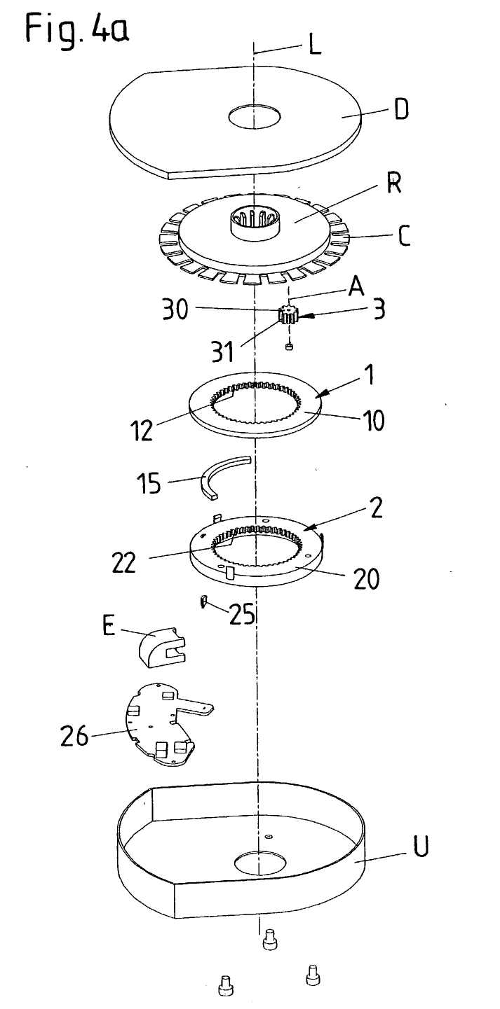

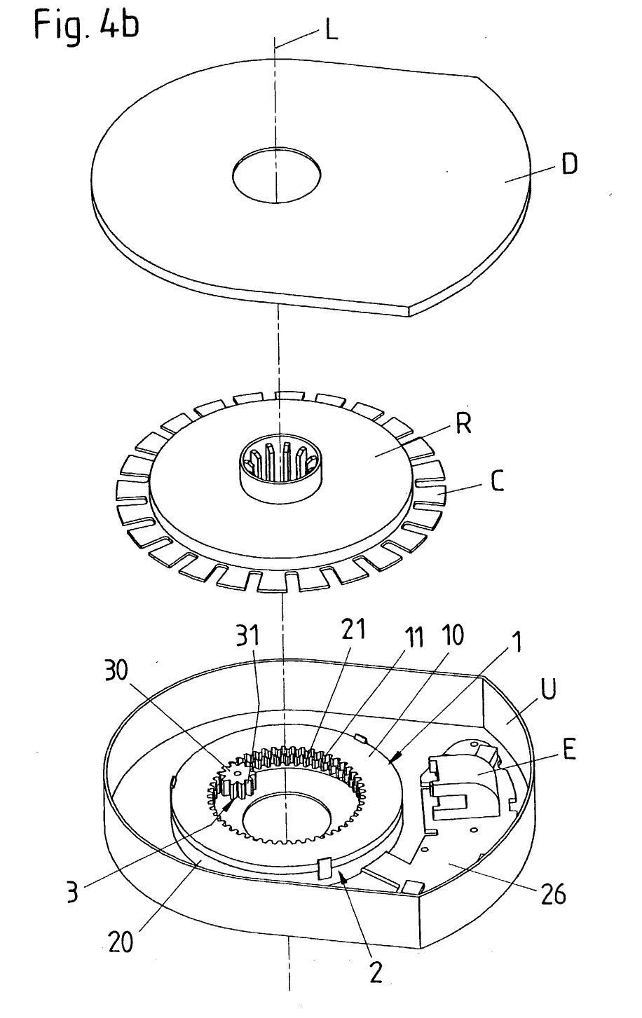

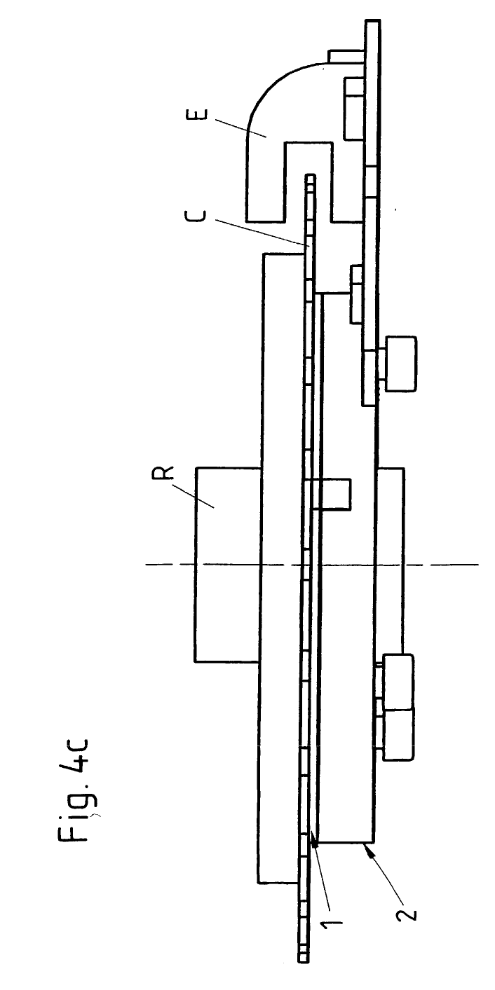

FIGS. 4a to 4c show a refinement of the exemplary embodiment from FIGS. 3a to 3c, the only difference being that the two gearwheels 1, 2 which are arranged coaxially one behind the other on the steering axle L are each provided with an internal toothing 12 and 22, respectively, and that the toothing 31 of the drive gearwheel 3 correspondingly intermeshes with the internal toothings 12, 22. For this purpose, the drive gearwheel 3 is arranged within the ring which is formed by the base elements 10, 20 of the two coaxially arranged gearwheels 1, 2.

In the exemplary embodiments of the invention which are illustrated with reference to FIGS. 3a to 3c and 4a to 4c, apart from a rough determination of the total steering angle (by means of the total number of rotations of the steering wheel, that is to say in particular beyond 360 degrees it is also possible to carry out a fine determination of the steering angle by means of the gearwheel 1, 2, 3, it is also possible to carry out a fine determination of the steering angle during one rotation (i.e., in each case between 0° and 360°) by means of the code C which can be sensed by a sensing device E. The measurement results of the steering angle which are generated by means of the gearwheels 1, 2, 3 and the assigned sensor device 15, 25 can be used not only for determining the number of rotations of the steering wheel (on the basis of a reference position) but also for plausibility checking of the steering angle determined by means of the sensing device E.

The priority application DE 101 58 287.0 filed Nov. 20, 2001, is hereby incorporated by reference herein.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A device for determining a steering angle of a steering wheel comprising:
a drive element, the drive element being driven by a steering wheel;
first and second gear elements, the first and second gear elements being arranged one behind the other on a common steering axle and operatively connected to the drive element, wherein the first and second gear elements are rotated with respect to one another when a steering angle changes;
a code carrier, the code carrier being formed by the first or the second gear element;
a device for sensing a code, the device for sensing the code being provided on the code carrier; and
wherein the code carrier and the device for sensing a code are rotated with respect to one another when the steering angle changes, the device for sensing the code generating an output signal from which the steering angle can be determined.

2. The device for determining a steering angle of claim 1, wherein the first and second gear elements each have a toothing, the drive element has a corresponding toothing, and the toothing of the first gear element and the toothing of the second gear element engages with at least one corresponding toothing of the drive element.

3. The device for determining a steering angle of claim 2, wherein the toothing of the first gear element and the toothing of the second gear element have a different number of teeth.

4. The device for determining a steering angle of claim 2, wherein the toothing of at least one of the first and second gear elements has a variation in the formation of the teeth along a circumference of the respective gear element.

5. The device for determining a steering angle of claim 1, wherein the first and second gear elements are formed by gearwheels.

6. The device for determining a steering angle of claim 1, wherein the first and second gear elements are rotated with respect to one another when there is a change in the steering angle, the first and second gear elements rotating through an angle that is smaller than the change in the steering angle.

7. The device for determining a steering angle of claim 1, wherein the first and second gear elements are rotated with respect to one another through an angle of less than 360° when the change in the steering angle is a maximum.

8. The device for determining a steering angle of claim 1, wherein the first and second gear elements are mounted on the common steering axle.

9. The device for determining a steering angle of claim 1, wherein one of the first and second gear elements is mounted on the common steering axle such that the fixedly mounted gear element fixed in terms of rotation, and wherein the other of the first and second gear elements is mounted on the common steering axle such that it is freely rotatable and is configured for use as a code carrier.

10. The device for determining a steering angle of claim 1, wherein the drive element is rotatably mounted.

11. The device for determining a steering angle of claim 1, wherein the drive element is moved along a path that encloses the common steering axle when the steering wheel rotates.

12. The device for determining a steering angle of claim 1, wherein the drive element is a gearwheel.

13. The device for determining a steering angle of claim 1, wherein the drive element is rotatably mounted on an axle which runs parallel to the common steering axle of the steering wheel.

14. The device for determining a steering angle of claim 1, wherein the drive element has a first toothing region and a second toothing region, the first and second toothing regions being arranged axially one behind the other, and wherein the first toothing region is engaged with one of the first and second gear elements and the second toothing region is engaged with the other of the first and second gear elements.

15. The device for determining a steering angle of claim 13, wherein the first and second toothing regions have the same number of teeth.

16. The device for determining a steering angle of claim 1, wherein a plurality of drive elements are provided, the drive elements being spaced apart from one another along a circumference of first and second gear elements.

17. The device for determining a steering angle of claim 1, wherein the first and second gear elements each have an external toothing.

18. The device for determining a steering angle of claim 1, wherein the first and second gear elements each have an internal toothing.

19. The device for determining a steering angle of claim 1, wherein a code is sensed by the device for sensing a code in accordance with an electrical, magnetic, or optical principle.

20. The device for determining a steering angle of claim 1, wherein the drive element is mounted so as to be capable of movement in a radial direction, an axial direction, or both a radial and an axial direction relative to the common steering axle of the first and second gear elements.

21. The device for determining a steering angle of claim 20, wherein the drive element is mounted to a radially movable bearing element.

22. The device for determining a steering angle of claim 1, wherein the drive element is spring-biased in the direction toward the first and second gear elements.

23. The device for determining a steering angle of claim 1, wherein a drive load is transmitted through the drive element into a gear mechanism formed by the first and second gear elements and the drive element.

24. The device for determining a steering angle of claim 1, wherein a sensing device with an assigned code is additionally provided for determining the steering angle within a rotation of the steering wheel.
